(19) United States
(12) Patent Application Publication
(10) Pub. No.: US 2016/0100595 A1
(43) Pub. Date: Apr. 14, 2016

(54) APPARATUS FOR PRESERVING COOKED FOOD PALATABILITY

(71) Applicant: PRINCE CASTLE LLC, Carol Stream, IL (US)

(72) Inventors: Loren Veltrop, Chicago, IL (US); Phillip Grisham, Bullard, TX (US); Brook Grisham, Palestine, TX (US); Michael Rainone, Palestine, TX (US); Clint Thompson, Palestine, TX (US); Talbot Presley, Palestine, TX (US)

(21) Appl. No.: 14/974,926

(22) Filed: Dec. 18, 2015

Related U.S. Application Data
(63) Continuation of application No. 13/326,667, filed on Dec. 15, 2011.

(51) Int. Cl. A23B 4/16; A47J 39/00; A23L 3/005; A47J 36/24

(52) U.S. Cl. CPC A23B 4/16; A47J 36/2488; A47J 39/006; A23L 3/005; A23V 2002/00

(57) ABSTRACT

The rate of degradation of a cooked food product that is maintained at an elevated temperature can be reduced by the use of an encapsulated environment food holder. The encapsulated environment is a small, airtight or semi-airtight containment vessel that retains compositions that escape from a cooked food product over time. The volume of an encapsulated environment is greater than one hundred percent but less than one-thousand percent of the cooked food product volume. By holding single servings or portions of a cooked food product in a small, encapsulated environment palatability or taste of a cooked food product can be extended.

### BACKGROUND

Many fast-food restaurants prepare food items before they are actually ordered and keep them warm until they are ordered by a customer. A pre-cooked or pre-prepared food product can thus be sold and served to the customer in significantly less time that it takes to prepare each food item after it is ordered.

A problem with pre-cooked foods is that they lose their taste or palatability over time. While taste or palatability is subjective, empirical data shows that most people will dislike the taste of a hamburger after it has been “held” or kept in a warming tray for more than about 15 minutes. Fast-food restaurant operators therefore keep pre-cooked foods warm and ready to serve for only a relatively short period of time, typically fifteen to twenty minutes. When that time has elapsed, the pre-cooked food product is disposed of. Extending the holding time of a pre-cooked food product is therefore contrary to the common and accepted practice of fast-food restaurant operators. Nevertheless, a method and apparatus for extending or preserving the palatability of a cooked food product would be an improvement over the prior art.

### BRIEF DESCRIPTION OF THE DRAWINGS

FIGS. 1A and 1B are views of one embodiment of an encapsulated environment device;

FIGS. 2A and 2B are view of an alternate embodiment of an encapsulated environment device;

FIG. 3 is a perspective view of a prior art food holding tray, depicted as holding encapsulated environment devices;

FIG. 4 is a front elevation of a food holding cabinet having food holding trays which hold pre-cooked food product enclosures therein;

FIG. 5 is a front view of a food holding cabinet having several encapsulated environment devices placed directly into the cabinet;

FIG. 6 is a perspective view of a heated grill or platen, which keeps encapsulated environment devices heated;

FIG. 7 depicts encapsulated environments under heat lamps and heated by infrared energy;

FIG. 8 is a sectional view of a solar oven warming several encapsulated environments; and

FIG. 9 is a flowchart depicting steps of a method for preserving the palatability of a cooked food product, using an encapsulated environment.

### DETAILED DESCRIPTION

As used herein, the term “encapsulated environment” refers to a device having an enclosed volume sufficient to enclose at least a single portion or single serving of a cooked protein-containing food product that a restaurant or food service would serve as a distinct menu item or as a constituent of a distinct menu item, and including a headspace of a sufficient size and volume to enable the retention of compositions including gases, released from a cooked protein-containing food product over time.

A single hamburger is an example of a menu item. A single hamburger patty is thus an example of a cooked, protein-containing food product for single hamburger menu item. A double hamburger, i.e., two hamburger patties provided with a single bun, is another example of a menu item wherein the single portion or single serving of a cooked protein-containing food product for the double hamburger menu item would be two hamburger patties. Several individual pieces of cooked chicken or fish can also be considered a single portion, if several pieces are offered as a menu item. Portion and serving are used interchangeably hereinafter.

As used herein, the term, “similar” means differing in size or position but not substantially different in shape. Two shapes are similar if one is larger than the other but they are otherwise the same or substantially the same.

The term “shape” refers to the configuration of a food product. Shape also refers to the configuration of an encapsulated environment for the food product. The shape of an encapsulated environment and the volume it encloses relative to the shape of a cooked food product is immaterial, but the shape of a volume enclosed by an encapsulated environment is preferably similar to the shape of the food product so that the excess size of the encapsulated environment, i.e., the volume of the encapsulated environment in excess of the food product volume, can be minimized. For example, if a cooked food product volume is considered to be 100%, the volume of the encapsulated environment needed to enclose the food product needs to be at least 100% of the cooked food product volume but can be up to as much as 1000% of the volume of the cooked food product (ten-times its value) for reasons set forth below.

The term, “cooked” means food that has been prepared for eating by means of heat. “Cooked” includes prepared for eating as required by, or as recommended by one or more of the U.S. Food and Drug and Administration (FDA), the United States Department of Agriculture (USDA), the National Sanitation Foundation (NSF) and/or the U.S. Department of Health and Human Services (HHS). By way of example, the USDA web site on its web site (www.FSIS.USDA.GOV) recommends that ground meat be cooked to an internal temperature of 160° F. The terms, cooked and pre-cooked are used interchangeably. A temperature of at least one-hundred forty degrees F. is believed to be a minimum holding temperature for a cooked food product. Temperatures greater than 212° F. will boil off water in a food product and accelerate degradation.

No known entity specifies or recommends how long a food product can be held at an elevated temperature and remain safe for consumption. A common and established practice of fast-food restaurants and food service institutions is to discard cooked food products after they have been in a holding cabinet for more than fifteen to twenty. Extending the holding time of a cooked food product thus contradicts common and established practice of the fast-food restaurants and food service industries generally.

The term “air tight” means that all or substantially all of the compositions, water, protein degradation products, volatile organic compounds, fats, including gases released from the cooked food product, will remain in an encapsulated environment for at least a non-zero length of time but not necessarily indefinitely.

A characteristic of a semi-airtight enclosure is that it has an interior pressure equal to the surrounding or ambient air pressure. Another characteristic is that there can be air or gas flow through a semi-airtight enclosure. As used herein, the term, “semi-airtight” means that the compositions, water, protein degradation products, fats, including gases released from the cooked food product, will be reduced within the encapsulated environment by some venting or escapement of air or gases from the cooked food product that is held within the encapsulated environment device. There is no pressure difference between the interior of the device and the exterior of the device.

The terms, “palatable” and “palatability” mean the property of being acceptable to the mouth or palate of individuals, especially the palate of an individual for whom a food product was prepared and cooked. Some individuals consider raw fish to be palatable while other individuals to be unpalatable. Palatable and palatability can thus include the perception and evaluation of acceptable food.

The term, “organoleptic” means, pertaining to the sensory properties of a particular food or chemical. Organoleptic quality includes the typical sensory properties of a food: its taste, appearance and color, aroma, size, firmness and sound when consumed.

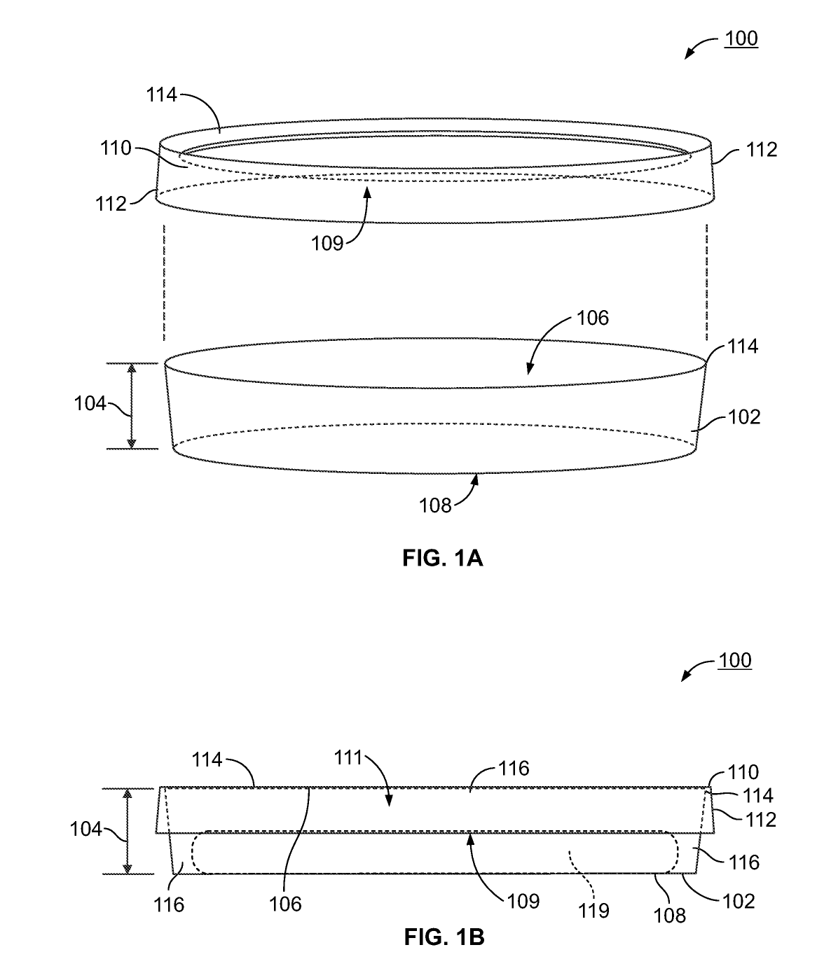

FIG. 1A and FIG. 1B are views of one embodiment of an encapsulated environment device 100. The general shape of the encapsulated environment device 100 depicted in FIG. 1A is reminiscent of a disc or a truncated right circular cylinder. The shape of the encapsulated environment device 100 is also similar to, or reminiscent of, the shape of a hamburger patty.

The encapsulated environment device 100 depicted in FIGS. 1A and 1B has a substantially cylindrical base 102 portion having a top-to-bottom height 104, an open top 106 and a closed, planar bottom 108. A cover 110 is sized and shaped to loosely fit over the open top 106 of the base portion 102. The loose fit of the cover 110 allows the cover 110 to be placed onto the base 102 and removed quickly and easily by hand.

When the cover 110 is placed over the open top 106 of the base portion 102 as shown in FIG. 1B, the cover 110 provides a semi-airtight volume 111 for a single portion of a food product, such as one hamburger patty, which has been cooked. The air tight volume 111 is defined by the area of the base 102 and the height 104 of the base 102. Somewhat less-effective encapsulated environment devices can nevertheless be realized if the cover 110 provides an -air tight volume 111. As explained below, the volume enclosed by the cover 110 and the effectiveness of encapsulated environment 100 can also be determined by the shape or configuration of the cover 108.

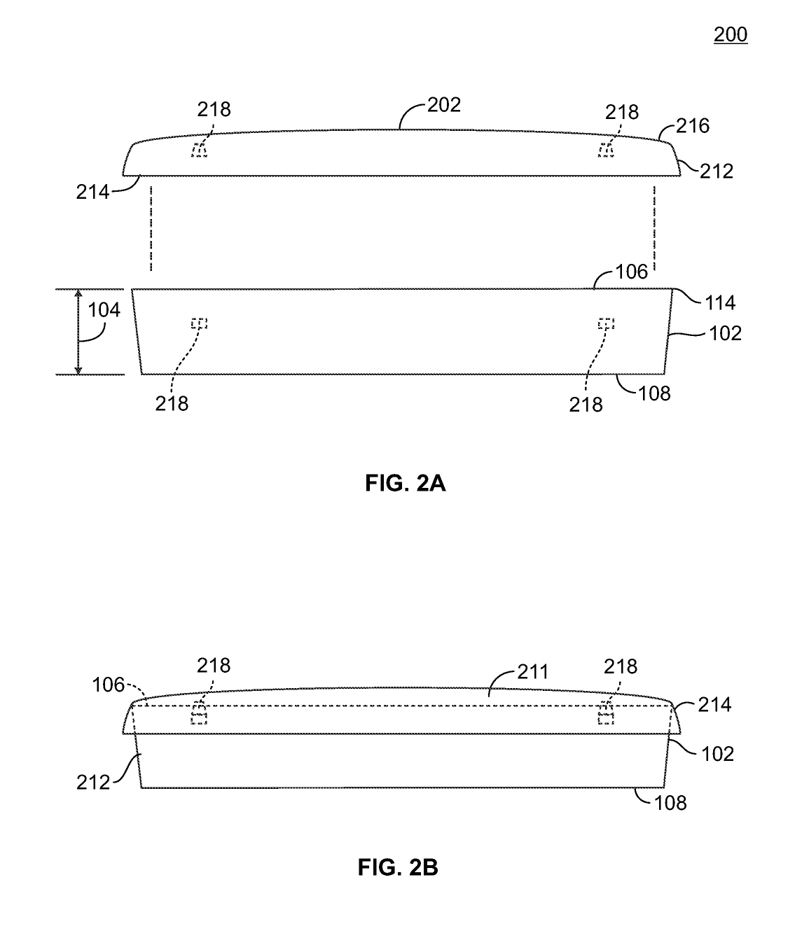

FIGS. 1A and 1B, show that the shape of the cover 110 is similar to the shape of the base 102. Like the base 102, the cover 110 has a cylindrical portion 112 with an open end 109 that faces downwardly, i.e., toward the open top 106 of the base 102. The cylindrical portion 112 has a closed end defined by a substantially planar top 114. The inside diameter of the cover cylindrical portion 112 is greater than the outside diameter of the base 102 in order to allow the cover 110 to fit freely over the base 102. When the cover 110 is placed over the base 102, the volume enclosed by the cover 110 can be increased if the planar top 114 portion of the cover 110 shown in FIGS. 1A and 1B is replaced by a convex on the outside, concave on the inside, or non-planar, three-dimensional curvilinear body, such as the one shown in FIG. 2.

FIG. 2A shows an exploded view of a second embodiment of an encapsulated environment 200 for a single portion of a food product, which is cooked before it is placed in, i.e., provided to, the encapsulated environment. The encapsulated environment shown in FIG. 2A has a differently-shaped cover 202 with a nevertheless generally cylindrical portion 212 having an open end 214 that faces downwardly toward the open top 106 of the base portion 102. FIG. 2B shows the cover 202 in place over the base portion 102. Unlike the cover 110 shown in FIGS. 1A and 1B, which has a planar top portion 114, the cover 202 shown in FIG. 2 has a concave top portion 216, the concave shape of which is reminiscent of a segment of a sphere. When the cover 202 shown in FIG. 2 is placed over the base 102, it will enclose a volume 211 greater than the volume that is enclosed when the cover 110 shown in FIGS. 1A and 1B is placed over the same base 106. The cover 202 will thus provide more headspace to the base portion 102 than will the cover 110 depicted in FIGS. 1A and 1B. The volume 211 and hence the headspace provided by an encapsulated environment can thus be determined by the shape or configuration of the cover, as well as the base. Optional vents 218 embodied as small holes, are shown in the cover 202 and the base 102 and insure that an encapsulated environment will not be airtight.

For purposes of claim construction, curvilinear bodies that could replace the planar top portion 114 of the cover 110 include but are not limited to: a hemisphere; a segment of a sphere, which is a portion of a sphere divided by a plane that intersects the sphere; a zone of a sphere, which is the portion of a sphere contained between two parallel or anti-parallel planes that both intersect the sphere. Other curvilinear bodies include catenoids, cones, conic sections and paraboloids of revolution.

As stated above, when a cover is placed over the base portion 102, it preferably provides a semi-airtight seal for the entire volume inside the base 102 and under the cover, however, an airtight seal will also provide at least some palatability time extension. Headspace is considered to be the open volume or the open space that is above, below or around a cooked food product in the base 102 and inside or below the cover for the base, regardless of the shape of the cover. The headspace provided by an open tray is thus virtually infinite, because there is no closure above the single servings of food product typically kept in a tray. And, the space around the food product is typically much greater than even ten times the volume of a single serving of a cooked food product.

In FIG. 1B, a single portion or single serving of a cooked food product in the encapsulated environment device 100 is represented by an elongated oval identified by reference numeral 118. Headspace 116 is considered to be open or unfilled volume around the food product 118, under the food product 118 and above the food product 118.

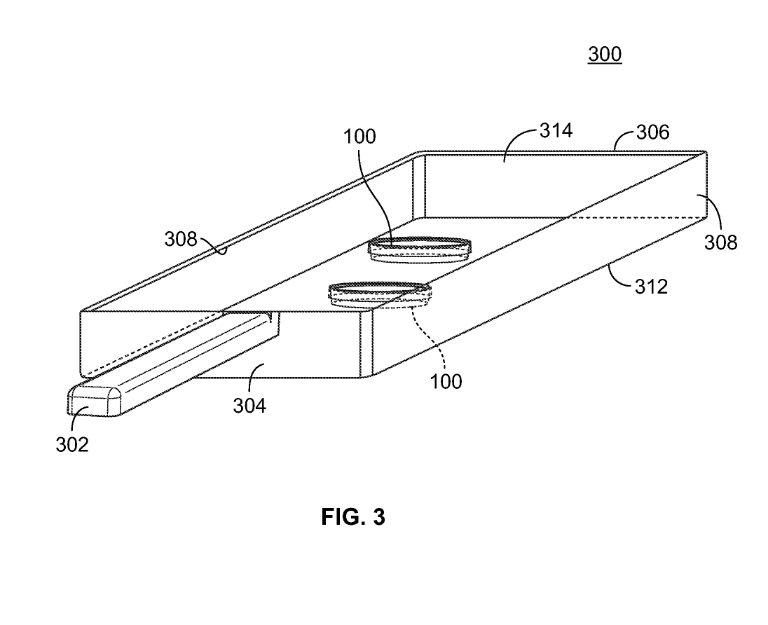

The headspace 116 accumulates compositions, including gases and liquids, released from a cooked food product 118 over time. Headspace 116 should therefore be of a sufficient but minimum volume required to hold such compositions, which can include protein and fat decomposition products, water, fats, oils, water vapor and including gases adjacent to cooked food products, which leave a cooked food product over time. The accumulation of compositions in the headspace 116 and in the encapsulated environment 100, which would otherwise escape from a cooked food product 118 and be lost to the surrounding environment over time, reduces the rate at which food degradation occurs, especially when the cooked food product is held at an elevated temperature. Stated another way, the accumulation of compositions in the headspace 116 and in the encapsulated environment 100, extends the time that a cooked food product, held at an elevated temperature, will be palatable. The food palatability extension is believed to be the result of maintaining contact between the food product and compositions that would otherwise be lost if the food product were to be held in a large tray, that is either open or closed, such as the tray 300 shown in FIG. 3.

Organoleptic tests show that the time that a cooked food product remains palatable at the elevated temperatures of a warming oven 100, can be extended if the cooked food product is stored in an encapsulated environment device for a single portion of a food product rather than in an open pan or tray, i.e., open to its surrounding environment, wherein multiple portions of a cooked food product can be kept at an elevated temperature. More specifically, organoleptic tests show that:

1) the smaller the head space, the longer a protein product can be held without significantly sacrificing palatability;

2) head space volume of the container can be as much as 10 times (one thousand percent) the volume of a cooked food product with the palatability of the held food product being retained for holding times that are in the one hour range;

3) hold time can be extended if moisture transport from the encapsulated environment during the warming/holding process is minimized but not eliminated;

4) meats and other protein products are preferably held in contact with most of the protein product fluids in the warming environment but other meats and protein products are preferably suspended or supported above protein product fluids;

5) semi-sealed containers exceed both airtight and open containers in maintaining the quality and flavor of the protein products, i.e., their palatability. An open-top food holding tray in which several cooked food products can be placed, and which is kept warm by placement into a heated holding cabinet, is an example of an open container that will not provide the results obtained by a semi-air tight or semi-sealed encapsulated environment, i.e., it will not extend the time that a food product is palatable as will an encapsulated environment.

As stated above, some meats and protein products are preferably kept suspended or supported above fluids that accumulate in an encapsulated environment. Chicken and fish are two such food products. Such foods can be kept separated from fluids in an encapsulated environment by providing corrugations to the bottom of the encapsulated environment, the grooves of which will collect fluids. They call also be kept out of accumulated fluids by adding a wire grating inside the encapsulated environment, which supports the food product above the bottom of the encapsulated environment.

Palatability evaluations of cooked food products held in encapsulated environment devices with different headspaces, for different lengths of time, and at different holding temperatures, and which were performed by trained taste testers, assessed the overall palatability of tested food products through analysis of their perceptions of flavor, color, moisture, texture and other panel standardized attributes. Such an evaluation measures the perception of palatability when losses of volatile organic compounds, fat, water and gases occur. Taste tests demonstrated that the taste differences between a hamburger patty kept in an encapsulated environment device for 1.5 hours or more, and a freshly-cooked hamburger patty were virtually indistinguishable.

Various test equipment also measured the presence of compositions, fats, volatile organic compounds, and protein degradation products released from the cooked food product to ensure the presence of the compositions, including gases during the storage period. One device for performing this function is commonly known as an artificial nose or electronic nose. Once a profile is made of the compositions including gases released from the food product which correlate with improved palatability over time, the flavor and odor of the food product can be read by the device.

“Electronic nose” sensors or analyzers are made by various manufacturers and distributed by various companies. Such manufacturers include Electronic Sensor Technology of Newbury Park, California, Smiths Detection of London, England, Microanalytics of Round Rock, Tex. and Alpha Mos America of Hanover, Md.

Notwithstanding the organoleptic test results provided above, in order for an encapsulated environment to hold a food product, the interior volume of the encapsulated environment cannot be less than the volume of the food product it is required to hold. An encapsulated environment should therefore be at least 100% of the volume of a cooked food product to be held but minimized but as stated above, the headspace can be up to ten-times the volume of the food product to be held. In embodiments where the headspace is more than twice the volume of a single portion, the excess headspace can of course be left empty but it can also be “filled” or provided an additional portion of a cooked food product, for every multiple that the headspace exceeds the single portion or serving volume. While the shape of an encapsulated environment device can be distinctly different than the shape of a cooked food product to be held, those of ordinary skill in the art will recognize that headspace can be minimized if the shape of an encapsulated environment for a cooked food product is “similar” to cooked food product itself. It is therefore preferable that an encapsulated environment shape be similar to the shape of a cooked food product.

The encapsulated environment, and its contents, must be kept warm in order to keep food palatable and safe for consumption, but it need not be kept warm in any particular type of warming device or cabinet.

FIG. 3 is a perspective view of a food holding tray 300 and depicts how the tray 300 can be used with encapsulated environment devices 100 for a single hamburger patty. The food holding tray 300 has a handle 302 that extends outwardly from a front wall 304. An opposing back wall 306 and opposing side walls 308 are attached to a bottom panel 312. An open top 314 allows the encapsulated environment device 100 to be put into or removed from the tray 300. When the tray 300 is put into a food holding cabinet, the holding cabinet will eventually raise the temperature of the encapsulated environment devices and their contents to the holding cabinet temperature.

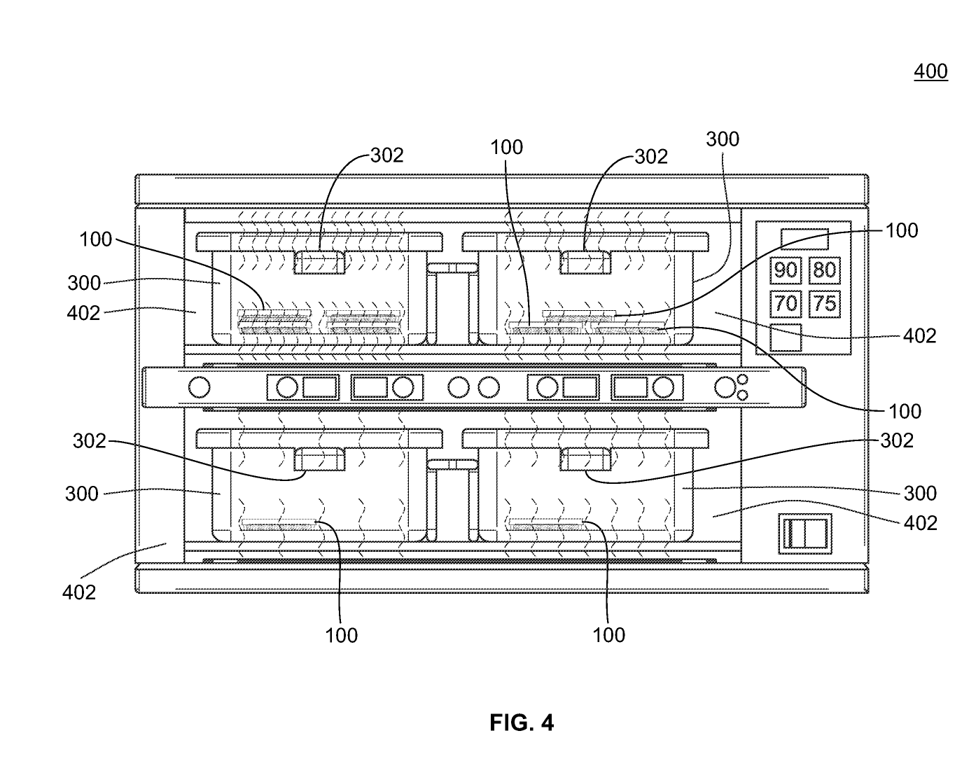

FIG. 4 is a front elevation view of a food holding cabinet 400 having four separate food holding trays 300. Each tray 300 is depicted as holding one or more encapsulated environment devices 100. Each encapsulated environment device 100 holds a pre-cooked food product.

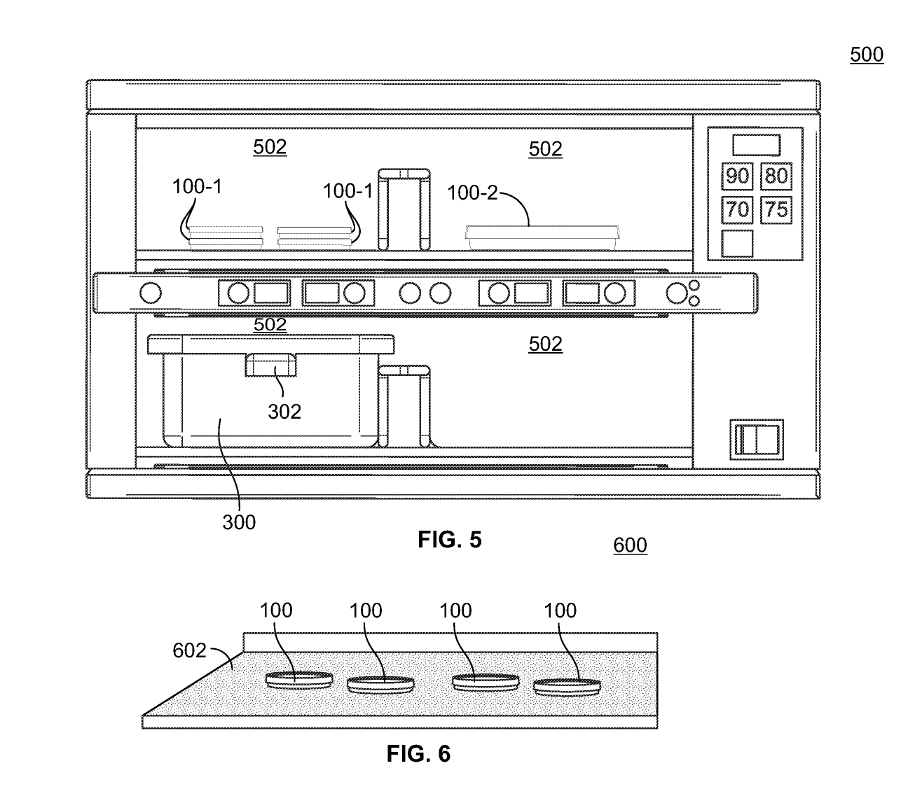

FIG. 5 is a front view of a food holding cabinet 500 having several encapsulated environment devices 100 stored directly into the compartments 502 of the holding cabinet 500, i.e., without being in a food holding tray. A first set of encapsulated environments, each of which is identified by reference numeral 100-1, is kept warm by their direct placement into the holding cabinet. A larger encapsulated environment 100-2, for a larger food item, is also kept warm by its direct placement directly into the holding cabinet. Direct placement of the encapsulated environments into a holding cabinet avoids what some users might consider to be an inconvenience of having to use an open tray.

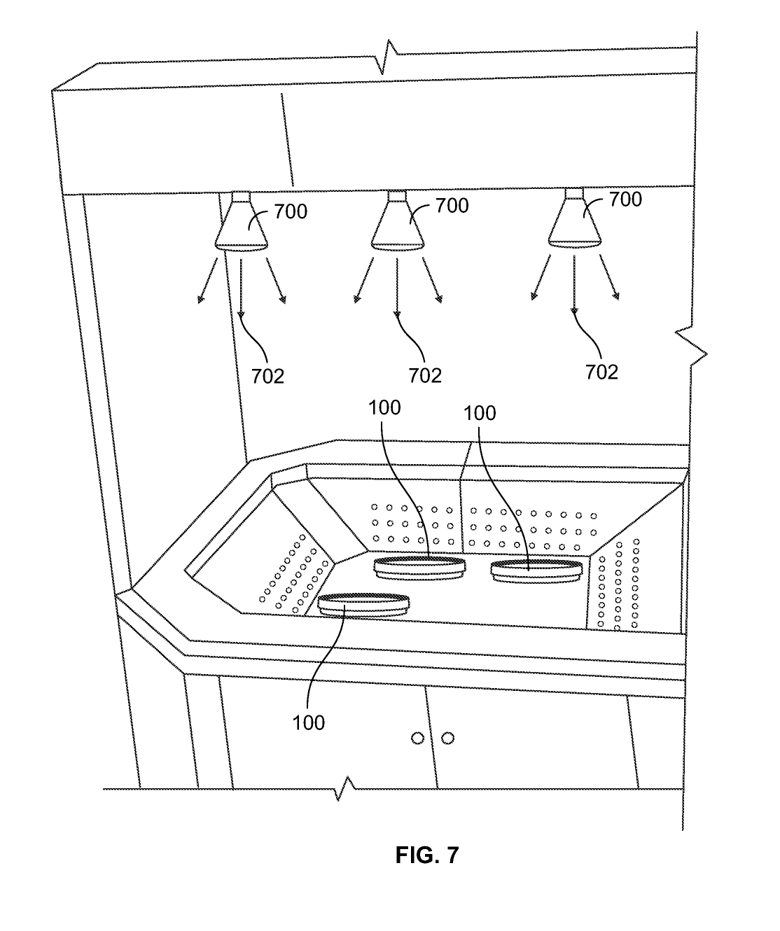

FIG. 6 is a perspective view of a heated platen or grill 600 on which several encapsulated environments 100 are placed and kept warm by heat conducted into them from the surface 602 of the platen or grill 600. In such an embodiment, the encapsulated environment is preferably made from metal rather than plastic or glass.

FIG. 7 is a perspective view of a several encapsulated environments 100 placed under heat lamps and heated by infrared energy. In such an embodiment, the encapsulated environments 100 can be made from either metal or plastic or glass. A metal encapsulated environment 100 will thus be heated by the infrared radiation it absorbs from a heat lamp. Food inside the metal encapsulated environment will thus be heated primarily by heat conduction rather than radiation. When the encapsulated environment 100 is made from material that allows at least some of the IR to pass through the material, the food product inside the encapsulated environment will be heated primarily by its absorption of IR.

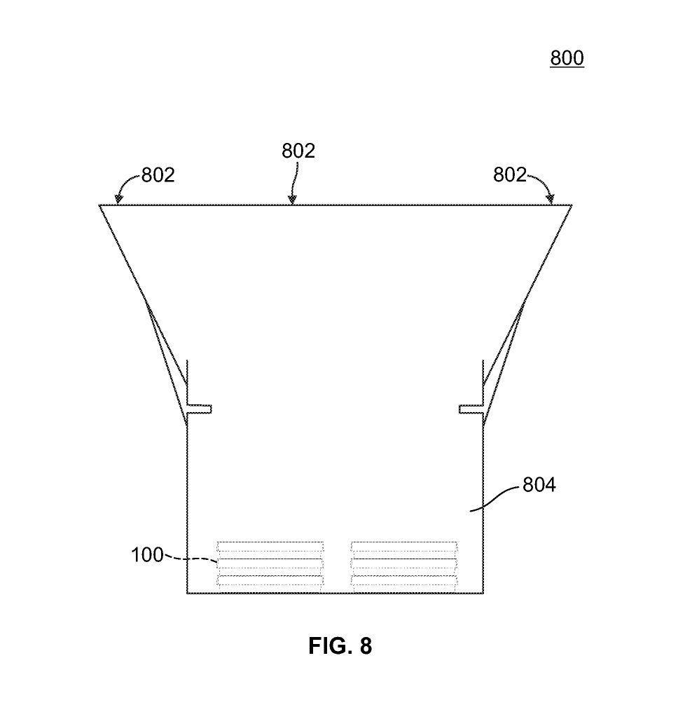

FIG. 8 is a sectional view of a solar oven 800 having reflective panels, which concentrate infrared energy into a cavity 804. Several encapsulated environments 100 are kept warm in the cavity 804 by solar or other source of infrared energy.

As used herein, the term “elevated temperature” refers to a temperature above which a cooked food product will be kept safe for humans to consume. Different authorities and agencies require or recommend different temperatures. A temperature above 140° F. can thus considered to be “elevated” as can 150° F. or higher.

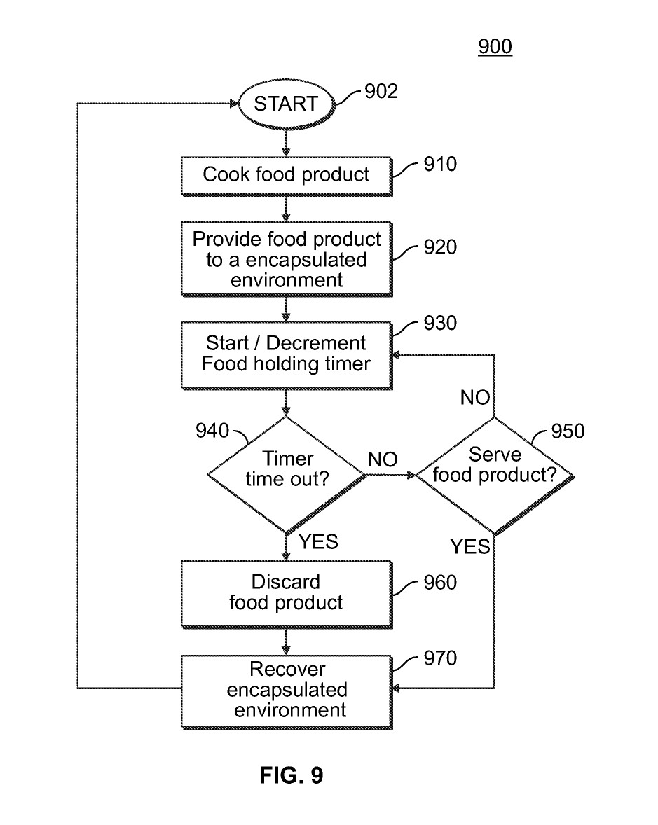

As stated above, experimental testing established that taste degradation of a cooked food product held at an elevated temperature is reduced and the palatability time extended when the food product is stored in an encapsulated environment device. Hamburger patties held at about 150° F. in an encapsulated environment devices remained palatable to trained taste testers after being held in an encapsulated environment device for as long as one and one-half (1.5) hours. Increasing the holding temperature will tend to shorten the maximum holding time due in part to the fact that the encapsulated environment devices are not completely air tight. Nevertheless, cooked foods can be held at temperatures between about 140° F. up to about 190° F. and their degradation reduced, and palatability maintained for much longer times than would otherwise be possible by holding the same food products in prior art food holding trays. FIG. 9 depicts steps of a method 900 for preserving the palatability of a cooked food product. The method starts at step 910 where a food product is cooked using a standard or conventional prior art cooking process. An example of such a process would be frying, broiling or baking.

At step 920, the cooked food product is provided to, or placed in, an encapsulated environment device for the food product. Examples of an encapsulated environment device are depicted in FIGS. 1A, 1B and 2. Step 920 includes the step of maintaining the temperature of the encapsulated environment and hence its contents at a temperature high enough to keep the food safe for consumption and/or comply with any applicable governmental regulations or safety guidelines. An encapsulated environment can be kept warm by its placement into a heated holding cabinet. It can also be kept warm other ways, such as by placement onto a heated surface, such as a platen or grill, placement under a heat lamp or within a solar-oven or a combination of such methods. The encapsulated environment temperature can be maintained several different ways. One or more encapsulated environments, with included food products, can be placed into a tray 108, such as the tray 300 in FIG. 3, which is then placed inside a food holding cabinet. One or more encapsulated environments, with included food products, can also be placed directly into a food holding cabinet. One or more encapsulated environments can also be placed onto a hot or warm surface, such as a grill. In one embodiment, the food in the encapsulated environment was maintained at a temperature above 150° F.

Keeping a cooked food product warm inside an encapsulated environment is facilitated if the material used to form the encapsulated environment device is at least a reasonably good thermal conductor. Preferable materials for encapsulated environment devices include stable plastics, such as polycarbonate plastics, high-impact polystyrene (HIPS), polyetherimide (PEI), which is also known as ULTEM®. Glass, of course, can also be used. Single-use encapsulated environment devices can be made from paper that is coated so that it will retain a shape and enclose a volume and provide at least a semi-airtight enclosure of the food product and headspace.

While storing a cooked food product at elevated temperatures inside an encapsulated environment will reduce its rate of degradation and thus extend the time that the cooked food product remains palatable, storing a cooked food product in an encapsulated environment will not extend the palatability time indefinitely. The maximum storage time for palatability will depend on several factors. Those factors include the type of the food product, the extent to which a food product was cooked before it was placed into an encapsulated environment, the temperature it is stored at inside the encapsulated environment, and as set forth above, the headspace inside an encapsulated environment and the amount of air that is permitted to pass through the encapsulated environment. Airtight encapsulated environments were determined to be less effective than semi-airtight encapsulated environments. Optional vents 218 in an encapsulated environment are therefore considered to be helpful in making an encapsulated environment semi-airtight in that they can be sized and arranged to control the amount and rate at which compositions released from a cooked, protein-containing food product are able to leave the encapsulated environment.

The number of vents and their size provided to encapsulated environments can be tailored for different types of food products. By way of example, the number, size and locations of vents provided to an encapsulated environment for a serving of chicken can be made different than the number, size and locations of vents provided for a serving of fish or a serving of a beef product.

Since foods cannot be held indefinitely, a food holding timer is started at step 930 to limit the time that a food product is held in an encapsulated environment and thereby avoid serving a food product that has degraded to a point where it is no longer palatable. The maximum time that a food product is held is thus preferably determined in advance or “predetermined” experimentally using at least some of the factors mentioned above. At step 940, a determination is made as to how long a cooked food product has been held in an encapsulated environment. If the maximum holding time has not expired, the product can be served at step 950 until the maximum holding time expires. If the food product is not extracted from the encapsulated environment and served for consumption by the time that the timer times out at step 940, the method includes the step of discarding the food product at step 960 and recovering the encapsulated environment for re-use at step 970.

The foregoing description is for purposes of illustration only. The true scope of the invention is set forth in the appurtenant claims.

1-8. (canceled)

9. An apparatus for preserving the palatability of a cooked food product having a predetermined volume, the apparatus comprising:
a food holding cabinet having a plurality of food holding compartments, at least one of the food holding compartments including a heating element that maintains a temperature of the food holding compartment at an elevated, food holding temperature of 140° F. or greater;
a food holding tray disposed within one of the food holding compartments; and
an encapsulated environment device disposed within the food holding tray, the encapsulated environment device being made from a material impermeable to liquids and gases emitted from a cooked food product that is disposed within the encapsulated environment device, the cooked food product displacing a first volume,
wherein an interior volume of the encapsulated environment device encloses the cooked food product within a predetermined headspace volume, the headspace volume being greater than one hundred percent of the first volume but less than one-thousand percent of the first volume.

10. The apparatus of claim 9, wherein the encapsulated environment is comprised of at least one vent.

11. The apparatus of claim 9, wherein the encapsulated environment is configured to maintain a cooked food product in contact with compositions from the cooked food product.

12. The apparatus of claim 9, wherein the encapsulated environment is configured to maintain a cooked food product separated from compositions from the cooked food product.

13. (canceled)

14. The apparatus of claim 9, wherein the heating device comprises the food holding tray.

15. The apparatus of claim 9, wherein the heating device is a grill surface.

16. The apparatus of claim 9, wherein the heating device is comprised of a source of infrared energy configured to direct infrared energy downwardly.

17. The apparatus of claim 9, wherein the heating device is comprised of a solar oven.

18. The apparatus of claim 9, wherein the encapsulated environment device has an interior shape that is substantially cylindrical.

19. The apparatus of claim 9, wherein the encapsulated environment device has an interior shape that is substantially a parallelepiped.

20. The apparatus of claim 9, further comprising a timer configured to measure a time period, prior to the expiration of which the cooked food product is served, after the expiration of which the food product is discarded.

21. The apparatus of claim 9, wherein the cooked food product comprises a cooked patty and wherein the encapsulated environment device comprises a substantially cylindrical base portion having a closed bottom and an open top, the encapsulated environment device further comprising a top, which is configured to fit over and close the open top of the base portion such that when the base portion and the top are assembled, they provide an enclosed volume.

22. A method of preserving the palatability of a cooked food product, the method comprising:
cooking a food product, the food product displacing a first volume;
placing the food product into an encapsulated environment device, the encapsulated environment device being made from a material impermeable to liquids and gases emitted from the food product, an interior volume of the encapsulated environment device enclosing the cooked food product within a predetermined headspace volume, the headspace volume being greater than one hundred percent of the first volume but less than one-thousand percent of the first volume; and
maintaining the food product at an elevated temperature of at least 140° F. within the encapsulated environment device.

23. The method of claim 22, further comprising:
venting some, but not all, of the compositions released from the food product out of the encapsulated environment device.

24. The method of claim 22, further comprising:
starting a timer after placing the food product into the encapsulated environment device; and
discarding the food product if the timer reaches a predetermined maximum holding time.

25. The method of claim 22, wherein the predetermined maximum holding time is greater than 15 minutes, but less than 1.5 hours.

26. The method of claim 22, further comprising:
placing the encapsulated environment device into a food holding cabinet, the food holding cabinet including a plurality of food holding compartments.

27. The method of claim 22, further comprising:
placing the encapsulated environment device into a food holding tray.

28. The method of claim 22, further comprising:
placing the encapsulated environment device onto a grill.

29. The method of claim 22, further comprising:
placing the encapsulated environment device under a heat lamp.
